(19) United States
(12) Patent Application Publication
(10) Pub. No.: US 2009/0009411 A1
(43) Pub. Date: Jan. 8, 2009

(54) HIGH EFFICIENCY ANTENNA HAVING COMPACT DIMENSIONS, PARTICULARLY FOR INSTALLATION ON A VEHICLE, SUCH AS AN AIRCRAFT OR A HIGH VELOCITY TRAIN OR A MOTOR VEHICLE

(75) Inventors: Alfredo Catalani, Rome (IT); Pasquale Russo, Rome (IT)

Correspondence Address: GAUTHIER & CONNORS, LLP, 225 FRANKLIN STREET, SUITE 2300, BOSTON, MA, 02110, US

(73) Assignee: SPACE ENGINEERING S.P.A., Rome (IT)

(21) Appl. No.: 12/046,822

(22) Filed: Mar. 12, 2008

(30) Foreign Application Priority Data
Mar. 27, 2007 (IT) RM2007A000154

(51) Int. Cl. H01Q 13/00; H01Q 1/32; H01Q 1/28

(52) U.S. Cl. 343/705; 343/837; 343/711

(57) ABSTRACT

This invention is related to a high efficiency antenna (1) having compact dimensions, particularly for installation on a vehicle, such as an aircraft or a high velocity train or a motor vehicle, comprising a main circular reflector (5), an illuminator (2) or feed, centrally mounted with respect to said main reflector (5), and a sub-reflector (3), mounted on said illuminator (2) by means of a positioning support member (4), said antenna (1) being installed upon a positioning member adapted to carry out azimuth and elevation polarisation movements.

### PRIORITY INFORMATION

The present application claims benefit from Italian Patent Application No. RM2007A000154, filed on Mar. 23, 2007, all of which is incorporated herein in its entirety.

### BACKGROUND OF THE INVENTION

1. Field of the Invention

This invention is related to a high efficiency antenna having compact dimensions, particularly for installation on a vehicle, such as an aircraft or a high velocity train or a motor vehicle.

2. Brief Description of the Art

More particularly, this invention relates to an antenna of the above said type for entertainment applications on vehicles in Ku band.

As it is well known, an ever increasing interest is now dedicated to new entertainment applications, such as television or Internet, to be utilised on moving mass transport means.

At present, all applications of this type utilise geo-stationary satellites operating in Ku band to carry out a transponder function to ground based gateway units.

Obviously, since a service of this kind is intended for use on vehicles, such as aircraft or high velocity trains in which the dimensions are of paramount relevance, it is evidently important that an approach be available as the one proposed by this invention that enables an antenna characterised by minimum dimensions to be achieved.

### SUMMARY OF THE INVENTION

It is an object of this invention to realise an antenna adapted to operate over the whole receiving band ranging from 10.70 GHz to 12.75 GHz as well as over the whole transmission band ranging from 13.75 GHz to 14.50 GHz.

It is a further object of this invention to realise a high efficiency antenna having restricted dimensions so as to make it amenable to be installed on vehicles, such as aircraft, high velocity trains, and like, with minimum effects as to the problems associated with the arrangement of outer devices mounted on the fuselage or on the body of the vehicle, in view of the fact that its overall dimensions are very small and it has an average radiation efficiency of nearly 60%.

These and other advantageous results are achieved according to this invention by proposing an antenna substantially consisting of a double circular reflector of offset type, wholly made of aluminium, realised by means of numerically controlled machines and by utilising an OMT, so that it will be possible to discriminate the Rx band from the Tx band and to simultaneously operate with two linear orthogonal polarisations.

It is specific subject matter of this invention, therefore, a high efficiency antenna having compact dimensions, particularly for installation on a vehicle, such as an aircraft or a high velocity train or a motor vehicle, comprising a main circular reflector, an illuminator or feed, centrally mounted with respect to said main reflector, and a sub-reflector, mounted on said illuminator by means of a positioning support member, said antenna being installed upon a positioning member adapted to carry out azimuth and elevation polarisation movements.

Preferably, according to the invention, said main reflector is provided with a central hole having the same dimensions as a lower flange provided in said illuminator, a spacer ring nut being provided on said illuminator.

Furthermore, according to the invention, said positioning support member is realised as a single piece of substantially frustum conic shape and with minimum volumetric dimensions and is characterised in that it minimises the secondary lobe of the radiation diagram in the two operation bands Tx and Rx in the main planes at 45° with respect to the planes of the support members.

Further according to the invention, the optical characteristic of said antenna is generated by starting from the outline of a Gregorian antenna provided with a double offset reflector rotated about a revolution axis.

Further according to the invention, said main reflector and said sub-reflector are realised by means of a two axis machine tool or by means of a numerically controlled lathe.

Furthermore, according to the invention, said illuminator and said support member are realised by lathe machining; the support member is subsequently reined by means of a grinding machine to realize the four struts(supports) by removing the excess material.

Additionally, according to the invention, said sub-reflector is provided with a lower ring nut adapted to space it from said support member.

Furthermore, said support member can be made of aluminium.

### BRIEF DESCRIPTION OF THE DRAWINGS

This invention will be now described by way of illustration not by way of limitation, according to its preferred embodiments, by particularly referring to the figures of the attached drawings, in which:

FIG. 1 is a perspective view of an antenna according to this invention;

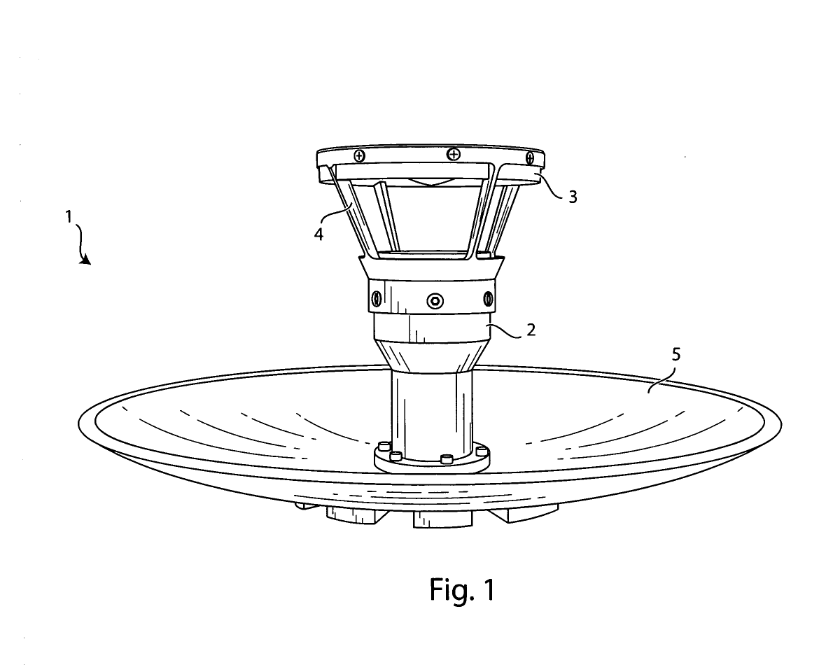

FIG. 2 shows a detail of the antenna of FIG. 1; and

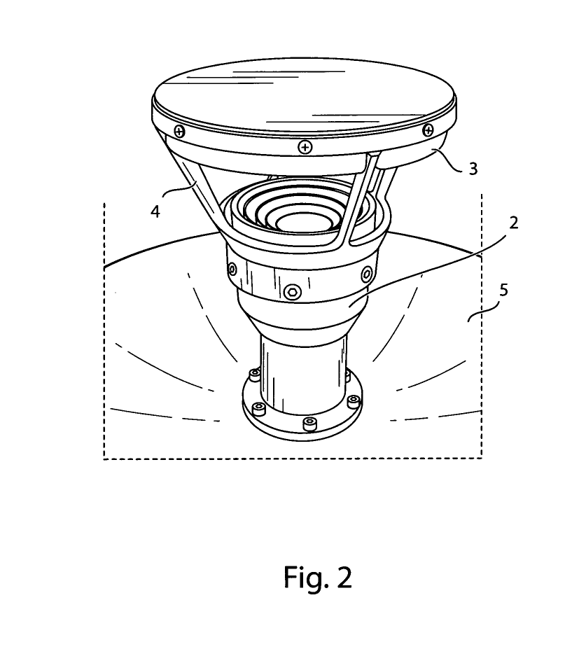

FIG. 3 illustrates the design principle of the antenna according to this invention.

### DETAILED DESCRIPTION OF THE INVENTION

By referring to the Figures of the attached drawings, an antenna according to this invention is shown, generally designated by reference numeral 1, which comprises a broad band illuminator (feed) 2, adapted to operate in Ku band of 10.7 GHz to 14.5 GHz, a circular sub-reflector 3, a metal support member 4, which correctly places sub-reflector 3 with respect to the illuminator 2, as well as circular reflector 5, or main reflector, forming the beam emanating from the antenna.

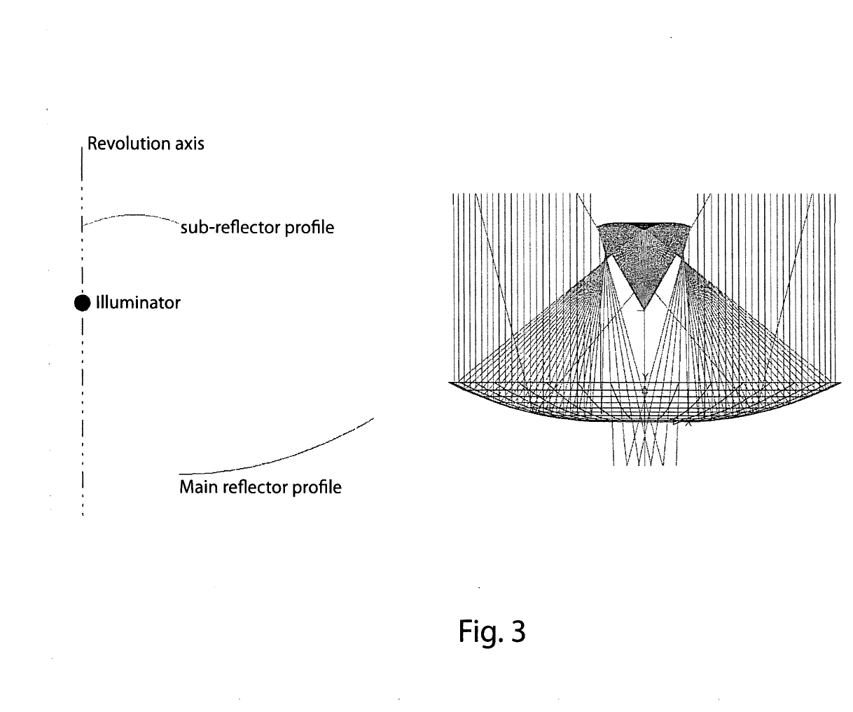

By particularly observing FIG. 3, it is to be noted that the optics of antenna 1 according to the invention is characterised in that it is generated by starting from a cassegrain antenna pattern having a double onset reflector; in a subsequent step, the surfaces of said sub-reflector and of the main reflector have been modified and optimised by means of a dedicated software: such a designing process enables the effects of the reflection of sub-reflector 3 upon the illuminator 2 itself to be mitigated, which effects otherwise would result into degradation of performances when expressed in terms of VSWR and in addition it enables the illumination characteristics of said main reflector 1 upon said sub-reflector 3 to be improved, thereby minimising the spillover losses.

In the embodiment illustrated in the drawings, an antenna is shown with a main reflector 5, having a disc of 360 mm diameter, a sub-reflector 3, having a disc of 120 mm diameter, with a centrally placed cusp and an illuminator 2 with four axial corrugations and having an aperture of 60 mm diameter.

Antenna 1 according to this invention was developed aiming at reducing the manufacturing costs and in order to achieve very precise alignment characteristics of the optics consisting of illuminator 2 plus sub-reflector 3 plus main reflector 5.

The realisation of main reflector 5 and of sub-reflector 3 can be carried out by means of a double axis machine tool or by means of a numerically controlled lathe, while illuminator 2 and support member 4 should be realised by lathe machining.

The central hole in main reflector 5, having the same diameter as illuminator 2 on the flange side, assures that said illuminator be centred under extremely high accuracy, while the abutting ring nut on illuminator 2 assures a correct distance between the mouth of illuminator 2 and the illuminator 5 itself.

Sub-reflector 3 has an abutting ring nut to assure its correct distance with respect to main reflector 5 by means of support member 4.

Support member 4 is made of aluminium and it is designed so as to cause a minimum shadowing effect in illumination of sub-reflector 3 on main reflector 5. Furthermore, since it is manufactured starting from a single, very compact, frustum conical piece, its structural strength characteristics as well as its accuracy characteristics in respect of its axial alignment, in addition to the correct distance between illuminator 2 and sub-reflector 3 are guaranteed.

By these means, an antenna 1 can be obtained which is distinctly characterised by high easiness in its assembling steps, having high alignment accuracy in all of its constituent parts and also having high efficiency in its radiation diagrams.

In addition, the provision of support members between sub-reflector 3 and illuminator (feed) 2 enables the antenna itself to be characterised in that the secondary lobe in the radiation diagram in the two operating bands (Tx and Rx) in the main planes (E plane and H plane) displaced at 45 degrees with respect to the planes containing the support members themselves is minimised. The advantage deriving from this feature can be appreciated in the transmission band when applying for the required authorisations from the relevant agencies that define the maximum radiation power limits as expressed by the ETSI rules.

The whole construction of antenna 1 appears to be scarcely affected by possibly present strong vibrations, such as the vibrations detectable on board of aircraft, while the intrinsic electrical performances of the antenna are maintained unaltered.

Antenna 1 according to this invention is designed so as to be installed upon a positioner adapted to carry out the required azimuth, elevation well as polarisation movements, and, as above said, as a result of a suitable optimisation effort, it has overall dimensions corresponding to the volume of a sphere of 385 cm diameter.

On the grounds of the preceding discussion, it can be concluded that antenna 1 according to this invention offers the noticeable advantage it turns out to be very compact and therefore it can be very easily installed on aircraft or generally on vehicles, since it minimises the effects of the radome on the aerodynamic performances of the aircraft.

In addition, the electric characteristics of the concerned antenna enable the system to reach adequate performances to realise protocol TCP/IP based connections between aircraft and satellite.

In view of the compactness characteristics, this antenna including its orientation system can be presently installed within a radome certified for flight and owned by Airbus which is being used on aircraft A340-600 but can also be installed on models A350-A380.

This invention has been described by way of illustration and not by way of limitation in connection with its preferred embodiments, but it should be understood that variations and/or modifications can be made by those skilled in the art without departing from the scope of this invention, as defined by the following claims.

What is claimed:

1. A high efficiency antenna having compact dimensions, particularly for installation on a vehicle, such as an aircraft or a high velocity train or a motor vehicle, wherein it comprises a main circular reflector, an illuminator or feed, centrally mounted with respect to said main reflector, and a sub-reflector, mounted on said illuminator by means of a positioning support member, said antenna being installed upon a positioning member adapted to carry out azimuth and elevation polarisation movements.

2. A high efficiency antenna having compact dimensions according to claim 1, wherein said main reflector is provided with a central hole having the same dimensions as a lower flange provided in said illuminator, a spacer ring nut being provided on said illuminator.

3. A high efficiency antenna having compact dimensions according to claim 1, wherein said positioning support member is realised as a single piece of substantially frustum conic shape and with minimum volumetric dimensions and further characterised in that it minimises the secondary lobe of the radiation diagram in the two operation bands Tx and Rx in the main planes at 45° with respect to the planes of the support members.

4. A high efficiency antenna having compact dimensions according to claim 1, wherein the surfaces of the reflectors are obtained after an optimisation process based upon dedicated software.

5. A high efficiency antenna having compact dimensions according to claim 1, wherein said main reflector and said sub-reflector are realised by means of a two axis machine tool or by means of a numerically controlled lathe.

6. A high efficiency antenna having compact dimensions according to claim 1, wherein said illuminator and said support member are realised by lathe machining and subsequent refining by grinding machine.

7. A high efficiency antenna having compact dimensions according to claim 1, wherein said sub-reflector is provided with a lower ring nut adapted to space it from said support member.

8. A high efficiency antenna having compact dimensions according to claim 1, wherein said support member is made of aluminium.

9. (canceled)
